(19) United States
(12) Patent Application Publication
(10) Pub. No.: US 2014/0131490 A1
(43) Pub. Date: May 15, 2014

(54) COMBINED TANGENTIAL SHEAR HOMOGENIZING AND FLASHING APPARATUS HAVING A NON-UNIFORM ROTOR/STATOR GAP DIMENSION AND A PARAMETER RESPONSIVE TO A VARIABLE ROTOR/STATOR GAP DIMENSION

(71) Applicant: E I DU PONT DE NEMOURS AND COMPANY, Wilmington, DE (US)

(72) Inventor: F Glenn Gallagher, Wilmington, DE (US)

(73) Assignee: E I DU PONT DE NEMOURS AND COMPANY, Wilmington, DE (US)

(21) Appl. No.: 13/790,223

(22) Filed: Mar. 8, 2013

Related U.S. Application Data
(60) Provisional application No. 61/724,587, filed on Nov. 9, 2012.
(60) Provisional application No. 61/724,594, filed on Nov. 9, 2012.

(51) Int. Cl. B02C 23/08; B02C 25/00

(52) U.S. Cl. CPC B02C 23/08; B02C 25/00
USPC 241/37; 241/68

(57) ABSTRACT

A combined tangential shear homogenizing and flashing apparatus for destructuring pretreated biomass comprises a housing connectable to a source of pressurized pretreated biomass, and a stator and a rotor mounted within the housing. The stator and rotor being confrontationally disposed and spaced apart by a non-uniformly dimensioned axial gap. The least axial dimension between the rotor and the stator defining a restriction to a biomass flow. In use, rotational movement of the rotor with respect to the stator imparts a tangential shear to a volume of pretreated biomass. The tangential shear homogenizes the volume of pretreated biomass while a pressure difference causes a partial phase separation of the homogenized biomass into vapor and liquid phases such that the pretreated biomass undergoes at least a three-fold total volumetric increase and a weight transition to a vapor of at least one percent (1%).

### CLAIM OF PRIORITY

This application claims priority from each of the following United States Provisional Applications, each of which is hereby incorporated by reference:

(I) Combined Tangential Shear Homogenizing and Flashing Apparatus Having A Uniform Rotor/Stator Gap Dimension, Application Ser. No. 61/724,581, filed 9 Nov. 2012 (CL-5598);

(II) Combined Tangential Shear Homogenizing and Flashing Apparatus Having A Non-Uniform Rotor/Stator Gap Dimension, Application Ser. No. 61/724,587, filed 9 Nov. 2012 (CL-5887);

(III) Combined Tangential Shear Homogenizing and Flashing Apparatus Having Rotor/Stator Gap Dimension With Uniform and Non-Uniform Regions, Application Ser. No. 61/724,590, filed 9 Nov. 2012 (CL-5888);

(IV) Combined Tangential Shear Homogenizing and Flashing Apparatus Having A Parameter Responsive Variable Rotor/Stator Gap Dimension, Application Ser. No. 61/724,594, filed 9 Nov. 2012 (CL-5889);

(V) Method For Flash Treating Biomass While Simultaneously Undergoing Tangential Shear Homogenization, Application Ser. No. 61/724,594, filed 9 Nov. 2012 (CL-5890);

(VI) Combined Tangential Shear Homogenizing and Flashing Apparatus Having A Housing With A Single Effluent Outlet, Application Ser. No. 61/724,604, filed 9 Nov. 2012 (CL-5891);

(VII) Combined Tangential Shear Homogenizing and Flashing Apparatus Having A Housing With Dual Effluent Outlets, Application Ser. No. 61/724,612, filed 9 Nov. 2012 (CL-5892); and

(VIII) System For Destructuring Biomass Including A Combined Tangential Shear Homogenizing and Flashing Apparatus, Application Ser. No. 61/724,620, filed 9 Nov. 2012 (CL-5873).

### CROSS-REFERENCE TO RELATED APPLICATIONS

Subject matter disclosed herein is disclosed in the following copending applications, all filed contemporaneously herewith and all assigned to the assignee of the present invention:

Combined Tangential Shear Homogenizing and Flashing Apparatus Having A Uniform Rotor/Stator Gap Dimension, application Ser. No. 12/______, filed Mar. ______, 2013 (CL-5598);

Combined Tangential Shear Homogenizing and Flashing Apparatus Having A Non-Uniform Rotor/Stator Gap Dimension and A Parameter Responsive To A Variable Rotor/Stator Gap Dimension, application Ser. No. 12/______, filed Mar. ______, 2013 (CL-5887, a cognate of CL-5887 and CL-5889);

Combined Tangential Shear Homogenizing and Flashing Apparatus Having Rotor/Stator Gap Dimension With Uniform and Non-Uniform Regions, application Ser. No. 12/______, filed Mar. ______, 2013 (CL-5888); and

System Including A Combined Tangential Shear Homogenizing and Flashing Apparatus Having Single Or Dual Effluent Outlet(s) and Method For Flash Treating Biomass Utilizing The Same, application Ser. No. 12/______, filed Mar. ______, 2013 (CL-5873, a cognate of CL-5873, CL-5890, CL-5891 and CL-5892).

### FIELD OF THE INVENTION

The invention relates to an apparatus for homogenizing cellulosic or lignocellulosic biomass by imposing tangential shear on the biomass while it is simultaneously exposed to a flashing operation, and more specifically, to a combined tangential shear Homogenizing and Flashing apparatus having a non-uniform rotor/stator gap dimension.

### BACKGROUND OF THE INVENTION

As the world's supply of crude oil is diminished there is growing interest in converting biomass into fuels and chemicals. Biomass is created through photosynthesis (using energy from the sun) where carbon dioxide is reduced and combined with water to form a wide range of organic polymeric structures. Biomass can be aquatic or terrestrial plants. Specific biomass sources include macroalgae (kelp), microalgae, energy crops (e.g., grasses, trees), crop residue (e.g., corn stover, forestry byproducts), biomass processing byproducts (e.g., bagasse, sawdust), as well as postconsumer products derived from aquatic or terrestrial plants (e.g., office paper, retail waste and municipal solid waste).

To be useful for further biological or chemical transformations the polymeric nature of biomass must be destructured. The first step of destructuring is commonly referred to as pretreatment. There is a universal need to efficiently destructure the biomass with minimal time, investment and energy.

Extensive work has focused on improving pretreatment. Various chemical pretreatment methods are known, including treatments with acids or bases, introducing solvents, water, enzymes, recycled destructuring reaction products, and chemical or biological agents or catalysts to promote depolymerization.

Such chemical pretreatment methods may be used in combination with mechanical pretreatment techniques that impose physical deformations on the biomass. These mechanical pretreatment techniques involve the use of apparatus that subject biomass at elevated temperatures and pressures to operations such as mixing, grinding and/or milling. These activities facilitate size reduction and/or the destructuring of the biomass. Under these pretreatment conditions the state of the biomass may be altered to the extent that portions of the biomass dissolve, liquify and/or melt. The state of the pretreated biomass ranges from solids, to compressible solids, to molten material and liquids or mixtures thereof.

It has been recognized that improved destructuring may be achieved by rapidly transitioning the biomass to lower pressure with a resulting flash and cooling of the biomass due to latent heat of vaporization of the flashed components. This state change may be referred to as flashing or steam explosion. The process may be complemented with additional steam in a jet cooker. The increased shear in the high velocity two-phase flow introduces gradients that disrupt some of the biomass structure. In general shear fields are in the flow direction, although turbulence may exist. The magnitude of the shear is dependent on the combination of the flow properties of the pretreated materials and the change in state for the apparatus (i.e., temperature and pressure). Thus, the shear is difficult to control independently of the biomass fluid properties.

It has been attempted to adjust the flashing operation with varying cross section in the flash device. Unfortunately, the flashing operation can be compromised by variations in the quality of the pretreated biomass flow characteristics and particulate size resulting in erratic performance or pluggage in the flash device. The pretreated biomass quality is a function of the variability of the biomass feed material (inherent genetics of the biomass, agronometry conditions, harvest, and storage conditions) and how the varying structure and composition of the biomass is transformed by the pretreatment activities.

In moving this pretreated biomass material from one vessel to another for treatments or subjecting the material to a flashing operation the variability of viscosity, solids content, and particle size may challenge proper operation of typical types of valves, nozzles, and metering devices and may result in erratic performance, instability, or pluggage.

For example, U.S. Published Application 2008/0277082 discloses a system with a flash across a valve. If the pretreated material flowing through the valve has variable flow characteristics the valve may plug. Similarly, in U.S. Published Application 2010/0317053 the plunger associated with the valve may not seal properly due to variations in the quality of the pretreated biomass and/or the presences of solids.

In view of the foregoing it is believed that there remains a need for an apparatus, method and system through which pretreated biomass can pass to achieve a flash operation while maintaining stable operation with minimal pluggage and the ability to subject the flashing biomass to shear forces independent of the flow properties of the pretreated biomass.

### SUMMARY OF THE INVENTION

The present invention relates to a method, apparatus and system for destructuring pretreated biomass at above atmospheric pressure and at an elevated temperature by discharge of the same into a reduced pressure zone (a flashing operation) defined within the housing of a combined tangential shear homogenizing and flashing apparatus that includes a stator and a relatively movable rotor. While the material is being subjected to flashing a tangential shearing force is imposed on the material by the action of the relatively moving rotor and stator. Introducing an independent tangential shear in a rotating device during the flashing operation homogenizes the volume of pretreated biomass. The apparatus provides inherently more stable performance due to the ability of the rotation to shear particles to a more acceptable size while systematically sweeping potential particle accumulations away from the flashing zone of the device.

In other aspects the invention is directed to a combined tangential shear homogenizing and flashing apparatus having various configurations of rotor and stator that results in different axial dimensions being defined therebetween the rotor and stator.

In yet another aspect the gap defined between the rotor and stator and/or the rotational speed of the rotor is/are varied in accordance measured parameters of the pretreated biomass, such as pressure, temperature, particle size and/or material composition.

In still other aspects the housing of the combined tangential shear homogenizing and flashing apparatus is provided with one or more outlet ports that direct communicate with a downstream process utility.

### BRIEF DESCRIPTION OF THE DRAWINGS

The invention will be more fully understood from the following detailed description, taken in connection with the accompanying drawings, which form a part of this application and in which:

FIG. 1 is a highly stylized schematic representation of a system for implementing a method for destructuring biomass that includes a combined tangential shear homogenizing and flashing apparatus in which a gap of uniform axial dimension is defined between the rotor and stator elements of the apparatus, all in accordance with various aspects of the present invention;

FIG. 2 is a highly stylized schematic representation of an alternate implementation of an embodiment of a combined tangential shear homogenizing and flashing apparatus in which a gap of uniform axial dimension is defined between the rotor and stator elements of the apparatus;

FIGS. 3 and 4 are highly stylized schematic representations of alternate implementations of an embodiment of a combined tangential shear homogenizing and flashing apparatus in which a gap of non-uniform dimension is defined between the rotor and stator elements of the apparatus;

FIG. 5 is a highly stylized schematic representation of yet another alternate embodiment of a combined tangential shear homogenizing and flashing apparatus in which a gap defined between the rotor and stator elements of the apparatus has regions that exhibit uniform and non-uniform axial dimensions;

FIG. 6 is highly stylized schematic representation of a modification useful with any of the embodiments shown in FIGS. 1 through 5 wherein a flow diverter is disposed in the entrance region of the mixing zone; and

FIG. 7 is highly stylized schematic representation of another modification useful with any of the embodiments shown in FIGS. 1 through 5 wherein the rotor and stator are provided with cylindrical portions that align to define an annular milling region in the entrance region of the mixing zone.

### DETAILED DESCRIPTION

Throughout the following detailed description similar reference characters refer to similar elements in all figures of the drawings.

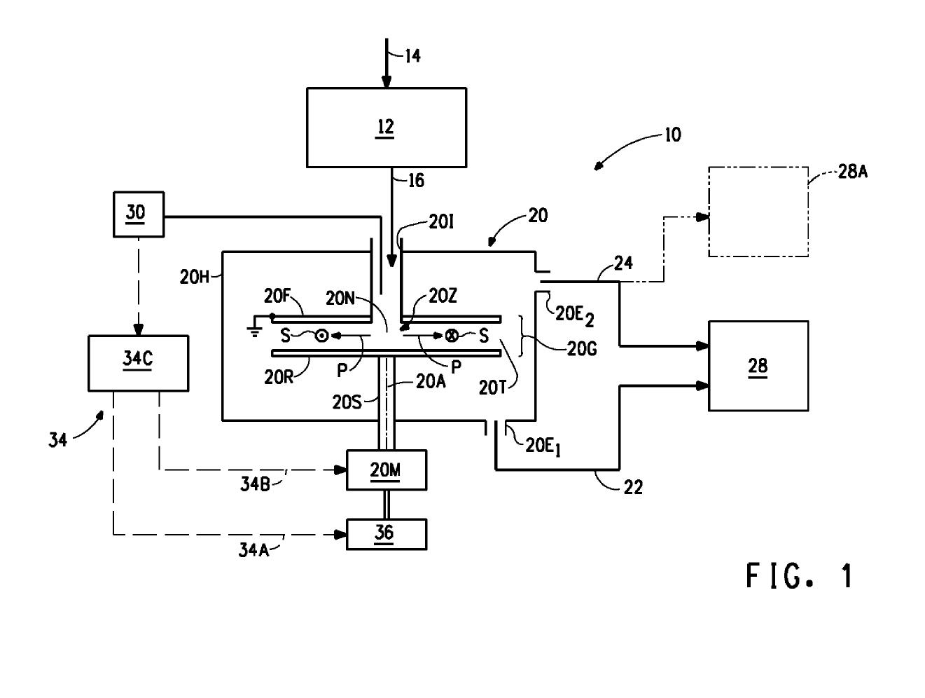

FIG. 1 is a highly stylized schematic illustration of a system generally indicated by reference character 10 for implementing a method for destructuring biomass, both in accordance with various aspects of the present invention.

The system 10 includes a pretreatment device 12 operative to pretreat one or more stream(s) 14 of raw cellulosic feedstock with processing aids such as water, solvents, compatabolizing agents, acids, bases and/or catalyst in preparation for destructuring and other further operations. Any suitable pretreatment operation on the biomass may be performed within the pretreatment device 12, as, for example, agitating, washing, pressurizing and/or heating the biomass to a predetermined elevated temperature. Pretreated material from the source 12 is conducted through a feed line 16 to a combined tangential shear homogenizing and flashing apparatus 20 also in accordance with the present invention.

The combined tangential shear homogenizing and flashing apparatus 20 itself comprises a housing 20H having an inlet port and channel 20I and at least a first effluent output port 20E₁. However, it lies within the contemplation of the present invention to provide a separate second output port 20E₂ for the housing 20H. A stator 20F and a rotor 20R are disposed within the housing 20H in confrontational orientation with respect to each other. In the arrangement illustrated in FIG. 1 the rotor and stator are parallel to each other and are oriented substantially perpendicular to the axis 20A.

The stator 20F is secured in a fixed disposition at any convenient location within the housing. The rotor 20R is mounted on a shaft 20S for relative rotation with respect to the stator. Motive force for the rotor 20R is provided by a drive motor 20M connected to the shaft 20S. The shaft 20S aligns with the axis 20A of the apparatus 20.

The stator 20S and the rotor 20R cooperate to define a mixing zone 20Z therebetween. The inlet channel 20I is connectible to the feed line 16 and serves to conduct pressurized biomass material from the pretreatment device 12 into the entrance region 20N of the mixing zone 20Z located in the vicinity of the axis 20A. The exit 20T of the mixing zone 20Z is disposed at the radially outer edge of the rotor 20R and communicates with the interior of the housing 20H and thus, with the first effluent output port 20E₁ and the second output port 20E₂, if present.

In a typical arrangement as illustrated in FIG. 1 the rotor and the stator are each substantially disk-shaped members. However, it should be understood that the rotor and stator can have any convenient three-dimensional configuration, peripheral shape and size. The surfaces of the rotor and stator can be smooth or patterned with groves or elevated sections so as to facilitate particle size reduction. The various structural elements of the apparatus 20 may be manufactured of any suitable materials of construction. The rotor, stator, housing may be preferably made from stainless steel. Various alternative structural configurations of the rotor 20R and stator 20S and the resulting modifications to the configuration of the mixing zone 20Z are discussed herein.

As will be described the apparatus 20 assists in the destructuring process by homogenizing the pretreated biomass while simultaneously causing a partial phase separation of the homogenized biomass into vapor and liquid phases. The distinct liquid and vapor phases so produced may be conducted singly or together directly to a processing utility 28 disposed downstream of the apparatus 20. If only a single effluent output port 20E₁ is provided both the liquid and vapor phases resulting from the homogenization and flash of the biomass are conveyed through a first conduit 22 to the utility 28. If the housing 20H is provided with a second output port 20E₂ the vapor phase is carried via the conduit 24 to the utility 28 and the liquid phase is conducted separately to the utility 28 through the first conduit 22. Representative of the various processing devices that may be used for the utility 28 include an agitating vessel for further destructuring.

However, it should be appreciated that flashed vapor of the biomass leaving the housing through the second outlet port 20E₂ may require different processing. Accordingly, the conduit 24 may be connected to an alternative processing utility 28A in which the vapor phase may be isolated for recycling and re-use or refined for various applications.

In a system in accordance with the present invention the conduits 22, 24 provide direct, uninterrupted fluid communication between the respective outlet ports 20E₁, 20E₂ and the particular utility(ies) 28, 28A to which they are connected. As used in this application the term “direct”, “directly” (or like terms) means that effluent(s) from the mixing zone 20Z is(are) conducted to their respective destination(s) without any impediment to fluid communication and without the need to pass through a separate intermediate device (such as a discrete flash or metering device).

The dimension of the mixing zone 20Z may be measured in a direction parallel to the axis 20A and is determined by the magnitude of the axial gap 20G between the rotor 20R and the stator 20F. Since in FIG. 1 the rotor and stator are arranged parallel to each other and are situated substantially perpendicular to the axis 20A, the gap 20G, and thus the axial dimension of the mixing zone, is uniform across the across the full radial extent of the mixing zone 20Z. It should be noted that if the confronting surfaces of the rotor and/or stator in any embodiment of the invention are patterned with grooves and/or elevated sections to facilitate homogenization the axial dimension of the gap between the rotor and the stator is defined as the underlying surface should the grooves and elevated sections be eliminated.

The dimension of the gap 20G may be adjusted by relocating the rotor with respect to the stator. Suitable expedients for manually adjusting the axial dimension of the gap prior to operation include shims, threaded shaft components, and hydraulic positioning devices. However, in the preferred case the dimension of the gap is automatically adjusted during operation by a gap adjustment control system 34 to be described.

The axial dimension of the gap is initially sized to a predetermined value based upon the particular pressure, temperature and nature of the biomass to be destructured. This initial sizing of the gap sets the predetermined appropriate initial axial dimension of the mixing zone 20Z. A predetermined volume of biomass having a predetermined pressure and temperature is introduced into the mixing zone 20Z through the inlet port 20I.

In operation, various properties of the pretreated biomass influent into the entrance 20N of the mixing zone 20Z are monitored by a sensor network generally indicated by reference numeral 30. The sensor 30 may include one or more sensing devices operative to monitor parameters such as pressure, temperature, particle size and/or composition (e.g., nature) of the pretreated influent biomass.

The flow of the pretreated biomass in a substantially radially outward direction through the mixing zone 20Z is controlled by the pressure difference between the entrance 20N and exit 20T. As the pretreated biomass flows radially outwardly through the mixing zone 20Z it undergoes a pressure drop. The pressure gradient vector, indicative of the change in pressure through the mixing zone, is indicated in the drawing by the vector P.

Simultaneously with the flow of pretreated biomass through the mixing zone 20Z the motor 20M rotates the rotor 20R with respect to the stator 20F. The relative rotational movement between the rotor and stator generates a circumferentially directed shear field within the mixing zone 20Z. The shear field imparts a tangential shear force to the volume of pretreated biomass flowing through the mixing zone 20Z. The direction of the tangential shear force is indicated in the drawing by the vector S. The tangential shear force homogenizes the pretreated biomass while the pressure difference across the mixing zone causes a partial phase separation of the homogenized biomass into vapor and liquid phases. Depending upon the particular structure of the rotor and stator the phase separation may occur within the radial extent of the mixing zone or within a predetermined close distance from the exit 20T thereof. In the case illustrated in FIG. 1 the partial phase separation occurs within the mixing zone.

In accordance with this invention selection of the predetermined initial size of the gap 20G coupled with the pressure differential and temperature of the biomass cause a partial phase separation of the homogenized pretreated biomass into vapor and liquid phases such that the biomass undergoes at least a three-fold total volumetric increase and a weight transition to a vapor state of at least one percent (1%).

Introducing an independent tangential shear force S in a rotating device during the flashing operation provides inherently more stable performance due to the ability of the rotation to homogenize particles to a more acceptable size while systematically sweeping potential particle accumulations away from the flashing zone of the device.

Due to the inherent inconsistencies of biomass composition and the manner in which various pretreatment operations impact these inconsistencies the resulting pretreated biomass in the flow line 16 may contain significant variations in fluid properties as well as size of discrete particles.

Accordingly, as a further aspect of the present invention the gap adjustment control system 34 enables the apparatus 20 and a system 10 incorporating the same to adapt automatically to adjust the gap 20G between the rotor and the stator and to compensate for such variations in pretreated biomass composition, flow properties and particulate size. This ability to vary the gap 20G allows the apparatus 20 also to function as a metering device.

In addition to the sensor 30 the gap adjustment control system 34 includes a programmable controller device 34C that is responsive to the signals from the sensor network 30 to vary the gap dimension 20G and thus, the axial dimension of the mixing zone 20Z, in accordance with one or more of the various sensed parameters of the influent pretreated biomass. The gap adjustment control system 34 may further include actuator 36 operatively connected to the motor 20M to physically effect adjustments to the gap dimension. The actuator 36 responds to a control signal from the control system 34 carried on a line 34A to move the motor and the rotor connected thereto as a unit toward and away from the stator thus to vary the gap dimension of the mixing zone based upon various measured parameters of the influent pretreated biomass. Thus, for example, the pressure of the biomass feed through the mixing zone 20Z may be maintained constant or varied in any predetermined way. Additionally or alternatively, for example, the gap dimension may be varied in a time-controlled manner to expel troublesome particles. It should be understood that various other expedients may be used to effect modification of the gap dimension, and that such other expedients are to be construed as lying within the contemplation of the present invention. For example, the gap dimension may be altered by displacing the stator within the housing relative to the rotor.

Alternatively or additionally, a signal from the control system 34 carried on a line 34B may be applied as a motor control signal to vary the rotational speed of the rotor 20M. Changing the rotational speed of the rotor facilitates particle size reduction.

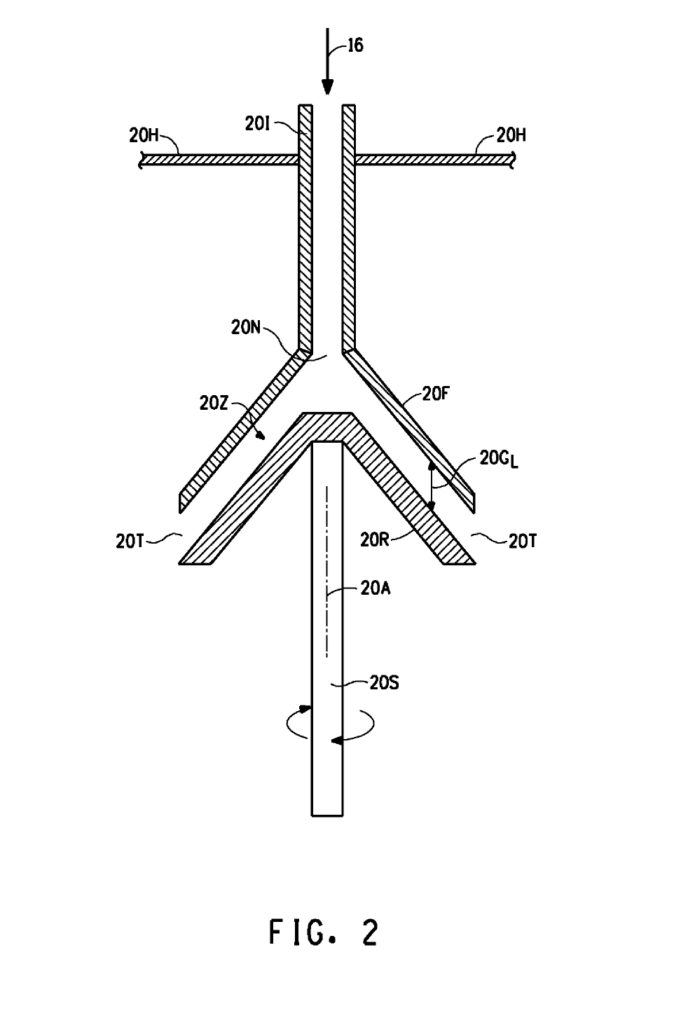

As mentioned earlier, in the arrangement shown in FIG. 1 the rotor and stator are each substantially disk-shaped members that are mounted parallel to each other and substantially perpendicular to the axis 20A such that the gap 20G is uniform across the entire radial extent of the mixing zone 20Z. FIG. 2 illustrates an alternate implementation of an apparatus 20 having a uniform axial dimension across the mixing zone but in which the rotor and stator are frustoconically shaped to facilitate material flow. Similar to the situation in FIG. 1, with the arrangement shown in FIG. 2 the flash occurs within the radial extent of the mixing zone.

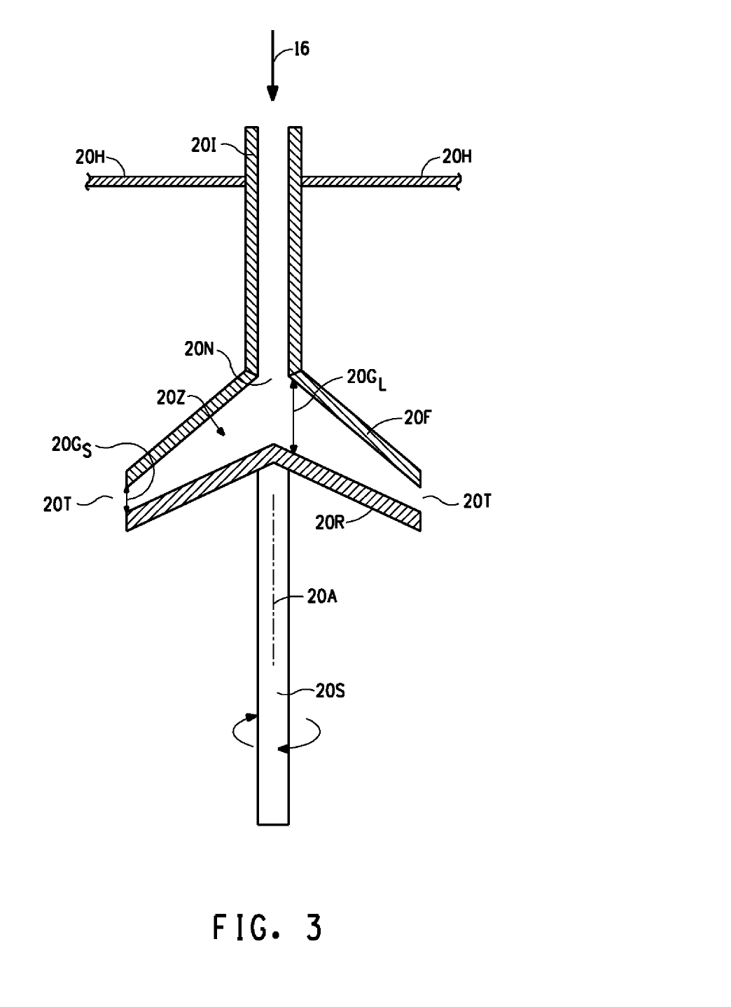

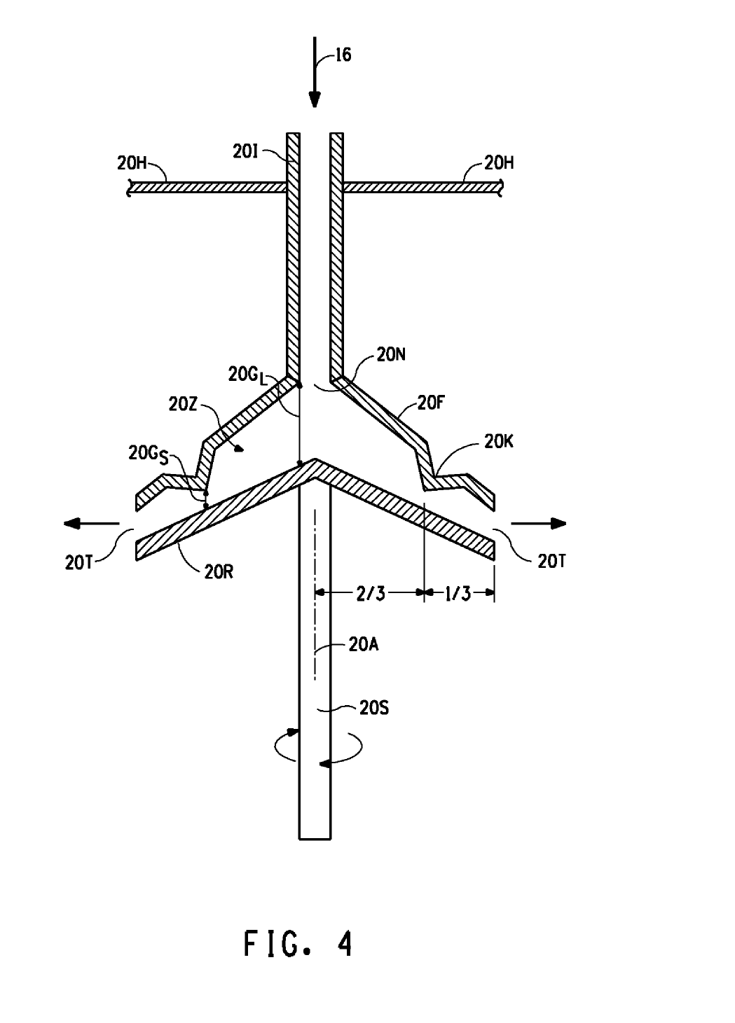

The location of the flash can be adjusted by appropriate adjustment of the geometry of the rotor and/or stator. FIGS. 3 and 4 illustrate two forms of an alternate embodiment of the apparatus 20 in which the mixing zone 20Z defined by the gap 20G between the rotor and stator has a non-uniform dimension. In these Figures the largest axial dimension 20G_{L} of the gap, and thus of the mixing zone, is located in the vicinity of the entrance 20N.

In the structure shown in FIG. 3 one (or both) of the rotor and/or stator is(are) frustoconically shaped members that are inclined with respect to the axis 20A such that the members taper uniformly toward each other at positions radially outwardly from the axis 20A. As a result of this structure the smallest axial gap dimension 20G_{S} occurs near the exit 20T at the radially outer edge of the mixing zone 20Z. The smallest axial gap dimension 20G_{S} presents a restriction to the substantially radially outwardly flow of biomass. In this form of the invention the partial phase separation occurs just past the radially outer edge.

The arrangement shown in FIG. 4 illustrates an construction in which the smallest axial gap dimension 20G_{S}, and thus the restriction to biomass flow, occurs at a selected location radially inwardly from the exit 20T of the mixing zone 20Z. In the arrangement shown in FIG. 4 the flow restriction should be not more than one-third of the radial distance of the mixing zone inwardly from the exit of the mixing zone. In FIG. 4 the restriction is defined by a constrictive feature 20K that is formed in the stator 20F. The partial phase separation occurs within the mixing zone in the vicinity of the feature 20K. It should be understood that an analogous feature may alternatively or additionally be provided on the rotor 20R.

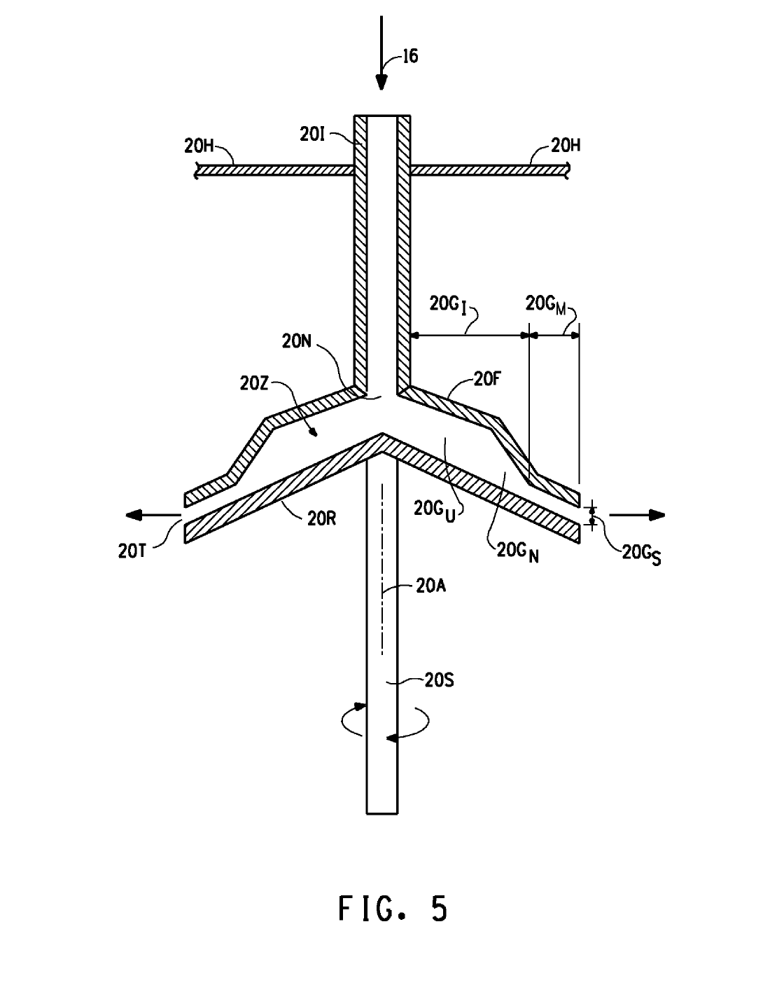

FIG. 5 illustrates another alternate embodiment of the apparatus 20. In this embodiment the rotor and the stator are configured to present a hybrid structure having a variety of gap configurations. A radially inner region 20G_{I} includes sections 20G_{U} and 20G_{N} having uniform 20G_{U} and non-uniform 20G_{N} axial dimensions, respectively. If desired, the section 20G_{J} of uniform dimension in the radially inner region 20G_{I} may be omitted. Alternatively, any convenient number of additional uniform and non-uniform sections may be provided in the radially inner region 20G_{I} if desired.

A radially outer region 20G_{M} has a uniform axial gap dimension and defines the smallest axial dimension 20G_{S} of the gap. The confronting surfaces of the rotor and stator in this region 20G_{V} cooperate to function as a metering device. The metering action provided by these surfaces regulates the exit pressure and provides improved pressure stability when compared to the structure of FIG. 4 where the smallest axial dimension 20G_{S} is a point contact.

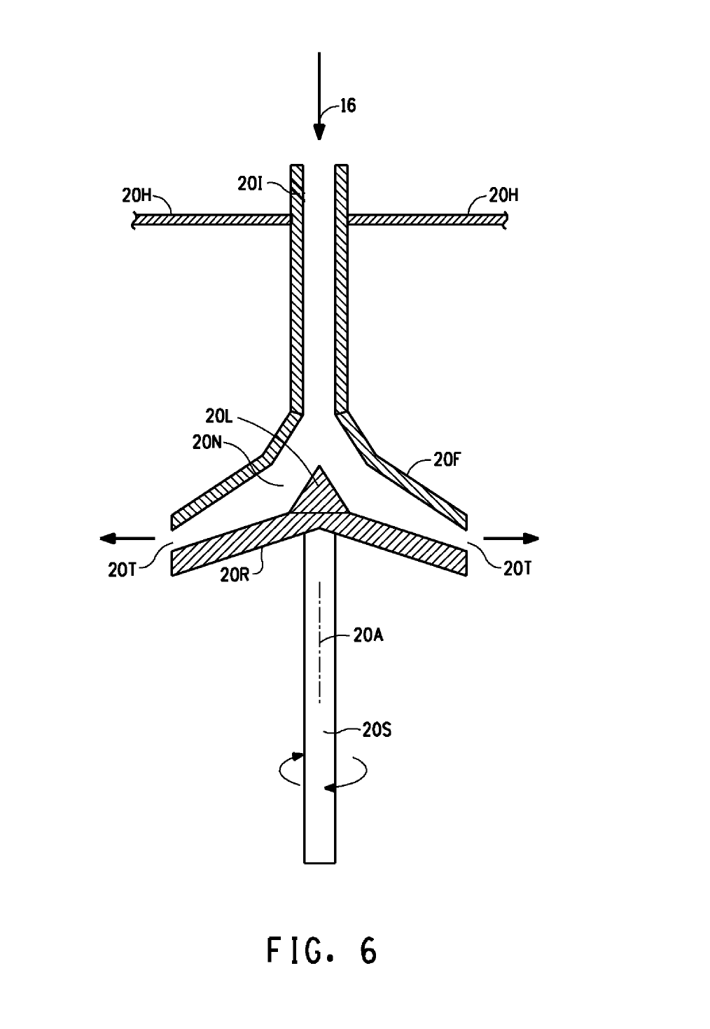

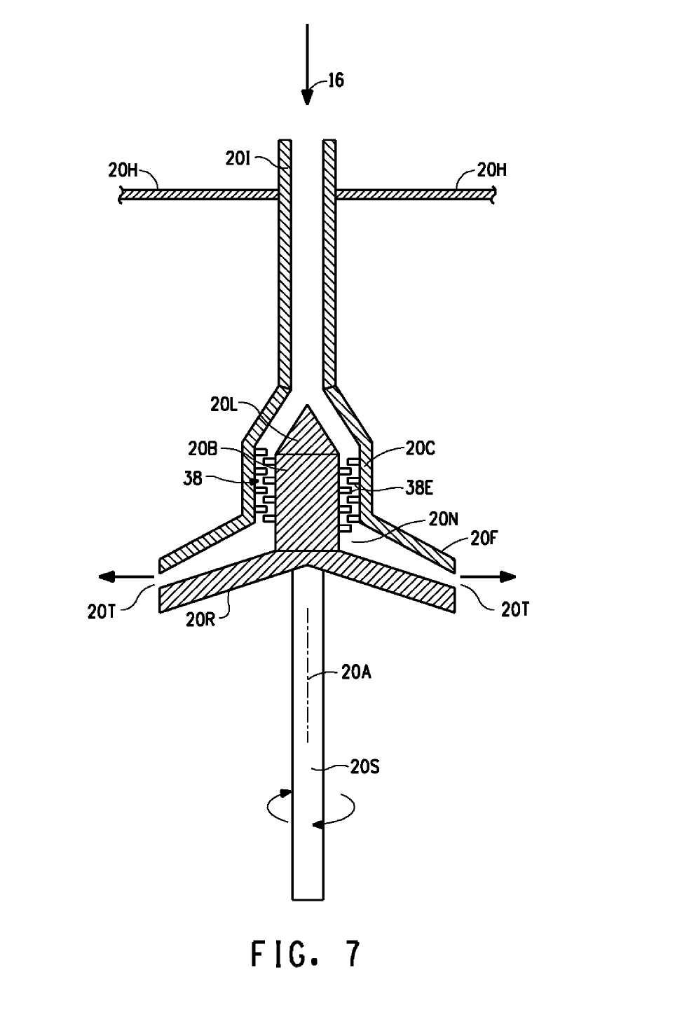

FIGS. 6 and 7 illustrate two additional structural details that may be used with any of the rotor/stator arrangements illustrated in FIGS. 1 through 5.

In FIG. 6 a flow diverter 20L is positioned between the rotor 20R and the stator 20F at a predetermined location near the entrance 20N of the mixing zone. The flow diverter 20L serves to streamline influent flow and avoid dead zones or abrupt direction changes that may lead to pockets of stagnant material. The flow diverter 20L may be mounted at any convenient location on either the rotor or the stator.

FIG. 7 illustrates an arrangement in which the apparatus is provided with a milling device disposed upstream of the entrance 20N of the mixing zone 20Z. The stator 20F has a substantially cylindrical portion 20C having a predetermined axial dimension formed thereon. Correspondingly, a substantially cylindrical barrel 20B mounted to the rotor 20R. The barrel 20B has a predetermined axial dimension. The barrel 20B extends axially from the rotor 20R into concentric nested relationship with the cylindrical portion 20C of the stator.

The barrel and the cylindrical portion of the stator cooperate to define an axially extending milling zone 38 disposed between the rotor and the stator. The axial dimension of the milling zone 38 is determined by the extent of axial overlap between the barrel 20B and the cylindrical portion 20C.

Any of a variety of mixing enhancers 38E may be may be incorporated on the barrel 20B and/or the walls of the cylinder 20C. In FIG. 7 the mixing enhancers 38E are shown in the form of pins. However, it is understood that other suitable forms of mixing enhancers, such as Maddock straight, Maddock tapered, pineapple, or gear may be used. Drawings of such mixing enhancers are shown in Perry's Chemical Engineering Handbook, Seventh Edition, FIG. 18-48.

Yet further, if desired, a flow 20L diverter may be mounted at the upstream end of the barrel 20B.

Those skilled in the art, having the benefit of the teachings of the present invention, may impart modifications thereto. Such modifications are to be construed as lying within the scope of the present invention, as defined by the appended claims.

1.-27. (canceled)

28. A combined tangential shear homogenizing and flashing apparatus for destructuring pretreated biomass comprising:
a housing having an inlet and at least one outlet, the housing having an axis extending therethrough, the inlet being connectable to a source of pressurized pretreated biomass while the outlet is connectible in direct fluid communication with a downstream utility; and
a stator and a rotor mounted within the housing, the stator and rotor being confrontationally disposed and spaced apart by an axial gap thereby to define a mixing zone communicating with the inlet and the outlet, the axial dimension of the gap varying at positions radially outwardly from the axis with the least axial dimension between the rotor and the stator being defined at a predetermined radial position, the least axial dimension between the rotor and stator defining a restriction to a biomass flow;
the rotor being connectable to a motor operative to rotate the rotor with respect to the stator, such that, in use, with a predetermined pressure difference defined between the inlet and the outlet, rotational movement of the rotor with respect to the stator imparts a tangential shear to a predetermined volume of pretreated biomass introduced into the mixing zone at a predetermined pressure and temperature while the biomass is moving through the mixing zone in the direction of the pressure difference,
the tangential shear being able to homogenize the biomass and the pressure difference being able to cause a partial phase separation of the homogenized biomass into vapor and liquid phases such that the pretreated biomass undergoes at least a three-fold total volumetric increase.

29. The combined tangential shear homogenizing and flashing apparatus of claim 28 wherein the pretreated biomass undergoes a weight transition to a vapor of at least one percent (1%).

30. The combined tangential shear homogenizing and flashing apparatus of claim 28 or 29 further comprising:
a sensor operative to monitor one or more of the pressure, temperature, particle size and/or composition (e.g., nature) parameters of the pretreated influent biomass; and
an actuator selected from: a) an actuator responsive to the sensor for relatively displacing the rotor and stator with respect to each other thereby to vary the magnitude of the gap in accordance with the monitored one or more parameter(s); and
b) an actuator responsive to the sensor for varying the magnitude of the rotational speed of the rotor in accordance with the monitored one or more parameter(s).

31. The combined tangential shear homogenizing and flashing apparatus of claim 28, 29, or 30 wherein the restriction is disposed adjacent to the radially outer edge of the mixing zone.

32. The combined tangential shear homogenizing and flashing apparatus of claim 28, 29, or 30 wherein the axial dimension of the gap tapers uniformly from the axis to the radially outer edge of the mixing zone, the smallest axial dimension of the gap defining the flow restriction.

33. The combined tangential shear homogenizing and flashing apparatus of claim 28, 29, or 30 wherein the restriction is disposed not more than one-third of the radial distance inwardly from outer edge of the mixing zone toward the axis.

34. The combined tangential shear homogenizing and flashing apparatus of claim 28, 29, or 30 further comprising:
a flow diverter mounted between the rotor and the stator for conducting biomass into the mixing zone.

35. The combined tangential shear homogenizing and flashing apparatus of claim 34 wherein the flow diverter is mounted to the rotor.

36. The combined tangential shear homogenizing and flashing apparatus of claim 34 wherein the flow diverter is mounted to the stator.

37. The combined tangential shear homogenizing and flashing apparatus of claim 28, 29, or 30 wherein the stator has a substantially cylindrical portion formed thereon, the cylindrical portion having a predetermined axial dimension; and wherein the apparatus further comprises:
a substantially cylindrical barrel mounted to the rotor, the barrel having a predetermined axial dimension, the barrel extending axially from the rotor into nested relationship with the cylindrical portion of the rotor,
the barrel and the cylindrical portion of the housing cooperating to define an axially extending milling zone therebetween.

38. The combined tangential shear homogenizing and flashing apparatus of claim 37 wherein the barrel of the stator has an array of mixing enhancers thereon.

39. The combined tangential shear homogenizing and flashing apparatus of claim 37 wherein the barrel has an axially upstream end thereon, and wherein, a flow diverter is mounted at the axially upstream end of the barrel.

40. The combined tangential shear homogenizing and flashing apparatus of claim 28, 29, or 30 wherein the rotor and the stator are substantially disc-shaped members that are both mounted substantially perpendicularly to the axis of the apparatus.

41. The combined tangential shear homogenizing and flashing apparatus of claim 28, 29, or 30 wherein the rotor and the stator are substantially frustoconically-shaped members that are both mounted with an inclination with respect to the axis of the apparatus.

42. The combined tangential shear homogenizing and flashing apparatus of claim 30 wherein the monitored parameter is the pressure of the pretreated influent biomass.
